(19) United States
(12) Patent Application Publication
(10) Pub. No.: US 2004/0212108 A1
(43) Pub. Date: Oct. 28, 2004

(54) Method of fabricating a photocrystalline plastic optical fiber

(76) Inventor: Jerome Fournier, Lyon (FR)

Correspondence Address: SOFER & HAROUN L.L.P., Suite 910, 317 Madison Avenue, New York, NY, 10017, US

(21) Appl. No.: 10/788,890

(22) Filed: Feb. 26, 2004

(30) Foreign Application Priority Data
Mar. 4, 2003 (FR) 03 02637

(51) Int. Cl. G02B 6/16; B29D 11/00

(52) U.S. Cl. 264/1.27

(57) ABSTRACT

A method of fabricating a photocrystalline plastic optical fiber comprises, for fabricating the cladding, a step of forming a flow by simultaneously injecting a liquid first composition that is a precursor of the cladding polymer and curable by ultraviolet radiation into a first series of holes in an injection plate, and a second composition that is unreactive to the ultraviolet radiation and is selected from a liquid composition and a gas composition into a second series of holes in the plate. The second series of holes have a substantially periodic distribution and each of the holes of the second series has as its closest neighbors holes of the first series. The method further includes a step of irradiating the flow with ultraviolet radiation to form the photocrystalline plastic optical fiber.

### BACKGROUND OF THE INVENTION

1. Field of the Invention

The present invention relates to the field of optical fibers, to be more precise to a method of fabricating a photocrystalline plastic optical fiber.

2. Description of the Prior Art

Plastic optical fibers with holes and photocrystalline plastic optical fibers have been known in the art for only a short time, such fibers having a cladding comprising a periodic arrangement of cavities of microscopic diameter, containing air and disposed longitudinally within a polymer material cladding matrix. The periodicity of the arrangement is broken by a defect that is created intentionally, serves as the core of the fiber, and is covered by the cladding, the size and the shape of the defect varying according to the arrangement.

Light may be confined within the core because it is guided by total internal reflection at the core/cladding interface. In this configuration, the core is generally solid and is formed of the same material as the cladding matrix.

Light may also be confined within the core by a cladding photonic band cutting effect (constructive interference of reflected and refracted rays). In this configuration, the core generally consists of air, and therefore has a lower refractive index than the effective refractive index of the cladding and a diameter larger than that of the air cavities, which are close together.

Like other fibers, photocrystalline plastic optical fibers are fabricated from a solid preform made from a plurality of polymer, for example polymethylmeth-acrylate (PMMA), capillaries and in some cases solid rods, these components being stacked to yield the required array after the fiber drawing process.

The main difficulty of using a solid preform is preserving the structure of the photocrystalline optical fiber over the whole of its length, as the cavities tend to become deformed or even to close up during fiber drawing, leading in particular to unacceptable optical losses in the fiber.

The aim of the invention is to provide a continuous, reliable and reproducible method of fabricating a photocrystalline plastic optical fiber that improves the performance of the fiber, in other words that raises the transmission level and/or widens the bandwidth, at the lowest cost.

### SUMMARY OF THE INVENTION

To this end, the invention proposes a method of fabricating a photocrystalline plastic optical fiber comprising a core made of a core material and a cladding covering the core, the cladding being formed of at least a first substantially periodic arrangement of cavities of a cavity material disposed longitudinally in a cladding polymer matrix, the method comprising, for fabricating the cladding:

a step of forming a flow by simultaneously injecting:

a liquid first composition that is a precursor of the cladding polymer and curable by ultraviolet radiation into a first series of holes in an injection plate, and

a second composition that is unreactive to the ultraviolet radiation and is selected from a liquid composition and a gas composition into a second series of holes in the plate, the second series of holes having a substantially periodic distribution and each of the holes of the second series having as its closest neighbors holes of the first series, and

a step of irradiating the flow with ultraviolet radiation to form the photocrystalline plastic optical fiber.

The method of the invention provides improved control over the structure of the photocrystalline plastic optical fiber and in particular the arrangement of the cavities.

The invention is based on the fact that although the compositions come into contact with each other there is no significant interdiffusion, the times of contact between the compositions in the method of the invention being sufficiently short, especially if the velocity of the flow is high.

The time of contact between the compositions is preferably less than one second.

The arrangement of cavities in the fiber obtained has substantially the same geometry as the arrangement of the second series of holes.

The expression “curable liquid composition” means a composition comprising at least one functional photocrosslinkable oligomer and/or polymer or a composition comprising at least one non-functional oligomer and/or polymer in solution in a functional photocrosslinkable monomer, or a mixture of the two.

In a preferred first embodiment of the invention, to simplify the fabrication of the fiber, the simultaneous injection operation for fabricating the core comprises injecting into a substantially central hole in the plate separate from any hole from the series of holes a third liquid composition that may be cured by ultraviolet radiation and is preferably identical to the first composition.

Thus the central hole contributes to the creation of a solid photocrystalline optical fiber core (i.e. a core filled with liquid or solid material).

In a preferred second embodiment of the invention, the simultaneous injection operation for fabricating the core comprises injecting into a substantially central hole in the plate separate from any hole of the series of holes a third composition which is unreactive to the ultraviolet radiation and is selected from a liquid composition and a gas composition.

In an advantageous embodiment, the simultaneous injection operation for fabricating a second periodic arrangement of cavities comprises injecting into a distinct third series of holes having a substantially periodic distribution a fourth liquid composition that is unreactive to the ultraviolet radiation and is preferably identical to the second composition.

In this way an optical fiber is obtained whose cladding matrix contains two types of arrangements of cavities. The interstitial cavities of the second arrangement are generally much smaller than the first cavities and are disposed around the majority of the first cavities and the core. One example of this kind of fiber is given in the paper on silica photocrystalline optical fibers entitled “Crystal fibre: the fibre of the future?”, OLE, Nadya Anscombe, December 2001, pages 23-25.

The method advantageously comprises, after the irradiation step, at least one step of eliminating at least one of the unreactive compositions, preferably by heat treatment if the unreactive composition is a liquid.

Hollow cavities (empty of solid or liquid material) may be formed independently of or simultaneously with forming a hollow core.

Because the elimination step leaves at least one region empty of liquid material, the method may comprise a step of filling the empty region, for example with a composition that does not flow under pressure.

The injection pressure of each unreactive gas composition is preferably higher than the injection pressure of the first composition.

The viscosity of each unreactive liquid composition is preferably higher than the viscosity of the first composition and preferably less than five times the viscosity of the first composition.

Each curable composition preferably contains a first reactive vinyl or acrylic monomer solvent and/or a first vinyl or acrylic polymer, each composition having an intrinsic attenuation of less than 5 dB/m.

The polymer may be halogenated or non-halogenated.

Each unreactive composition may contain a compound selected from gases such as nitrogen, air, argon, unreactive solvents such as xylenol, fluorinated solvents, butylene glycol, propylene glycol, butyl propanol, cyclohexanone, aliphatic alcohols, lactates, silicone-containing oils, and biodegradable polymers such as cellulose polymers.

The features and advantages of the invention will become clearly apparent on reading the following description which is given by way of illustrative and non-limiting example and with reference to the appended drawings.

### BRIEF DESCRIPTION OF THE DRAWINGS

FIG. 1 depicts diagrammatically in cross section a photocrystalline plastic optical fiber obtained by a preferred embodiment of a fabrication method of the invention.

FIG. 2 depicts diagrammatically the use of the preferred embodiment of the method of the invention of fabricating the photocrystalline plastic optical fiber from FIG. 1, with a reduction cone.

FIG. 3 depicts diagrammatically the use of the preferred embodiment of the method of the invention of fabricating the photocrystalline plastic optical fiber from FIG. 1, without a reduction cone.

FIG. 4 is a diagrammatic perspective view of an injection plate having a similar structure to that used in the preferred embodiment of the method of the invention.

### DETAILED DESCRIPTION OF THE PREFERRED EMBODIMENT

In all the figures, common items carry the same reference numbers.

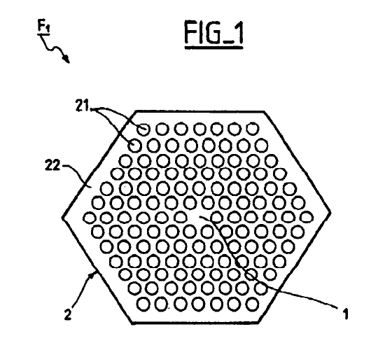

FIG. 1 depicts diagrammatically in cross section a photocrystalline plastic optical fiber obtained by a preferred embodiment of a fabrication method of the invention.

For example, the photocrystalline plastic optical fiber F₁ has a diameter from 100 to 1000 μm and a hexagonal structure comprising a solid core 1 with a diameter from 1 to 100 μm and a cladding 2 covering the core 1.

The cladding 2 is formed of a periodic arrangement, a hexagonal arrangement in this example, of cavities 21 that are substantially circular and of microscopic diameter, for example. The expression “microscopic diameter” means an average cavity diameter less than one micrometer, of the order of one micrometer or of the order of ten micrometers. The diameter is from 1 to 30 micrometers, for example, in the present example.

These hollow cavities (empty of solid or liquid material), containing air, for example, are disposed longitudinally in a cladding polymer matrix 22 obtained by ultraviolet radiation. In this example the shortest distance between two cavities is less than the radius of a cavity.

To simplify fabrication, the material of the core is identical to the cladding polymer.

In a variant, the hollow cavities contain any other gas.

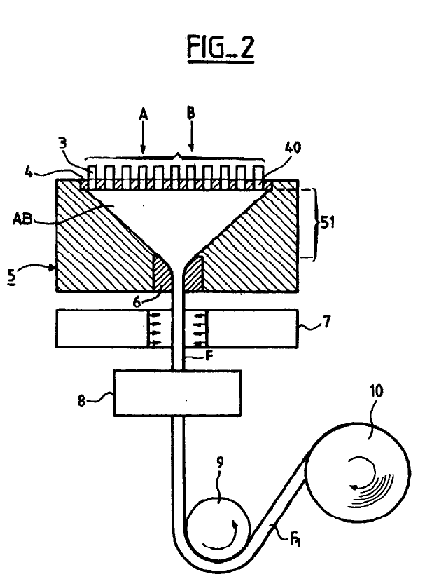

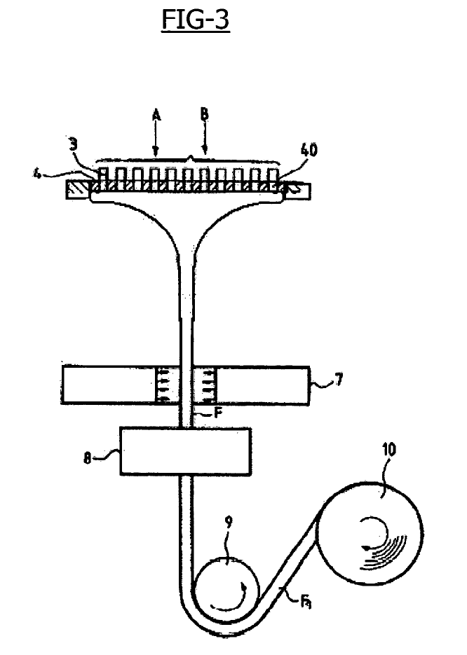

FIGS. 2 and 3 depict diagrammatically the use of the preferred embodiment of the method of the invention of fabricating the photocrystalline plastic optical fiber F₁ from FIG. 1.

In a first step of the method, at least one liquid composition A that may be cured by ultraviolet (UV) radiation and at least one other composition B that is unreactive to the UV radiation for curing the composition A, for example a liquid composition, are simultaneously injected under pressure into an injection plate 4 so that a flow AB is formed.

Also, injection conduits 3 that do not communicate with each other are disposed in the upper portion of the injection plate 4, for example in the form of a disc with holes 40. The plate is disposed in a flow chamber 5 of stainless steel, for example (seen in cross section in FIG. 2). Positive displacement pumps (not shown) associated with each of the conduits 3 produce controlled pressures in the liquid compositions A and B, for example pressures of the order of 6 bar.

To be more precise, the composition A is a cladding polymer precursor composition and contains a first reactive solvent of the monomer type and/or a first vinyl or acrylic polymer, halogenated or non-halogenated. The first composition A preferably has an intrinsic attenuation of less than 5 dB/m.

In the case of the solid core fiber F₁, the composition A is also the precursor composition of the core polymer.

The liquid composition B contains a compound selected from unreactive solvents such as xylenol, fluorinated solvents such as FC-77, butylene glycol, propylene glycol, cyclohexanone, silicone-containing oils, and biodegradable polymers such as cellulose polymers. The composition B preferably contains a mixture of a unreactive solvent such as those listed hereinabove and a biodegradable polymer, in a ratio chosen to control the viscosity of the composition.

The viscosity of the composition B is preferably higher than the viscosity of the composition A to optimize the formation and the required profile of the flow AB. The viscosity of the composition B preferably does not exceed five times the viscosity of the composition A. The viscosities are selected in the range 200 mPa.s to 5000 mPa.s at 25° C.

Choosing the viscosity of the composition B allows the diameter of the cavities in the fiber F to be adjusted: the lower the viscosity, the smaller the diameter of the cavities in the fiber F.

In the FIG. 2 embodiment, the next step is a step of reducing the diameter of the flow AB by means of a conical region 51 of the chamber 5 known as a reduction cone, whose upper boundary is the lower boundary of the injection plate 4. This geometrically similar variation of the diameter retains for the flow AB the concentration profile of the composition A and the composition B without interdiffusion between them.

The flow AB is conducted through the region 51 to the calibrated die 6 which imparts the required order of magnitude to the diameter of the fiber F. The die 6 is a removable component so that the calibration can be changed easily without having to change the chamber 5. In a variant, the die 6 may be a portion of the chamber 5.

The die 5 has a hexagonal structure, for example.

An at least partly cryogenic cooling system may be disposed in the conical region 51 to increase the viscosity of the flow AB to a value compatible with drawing it.

Likewise, a thermally insulated device may be placed on the conduits 3 to obtain the required viscosity of the composition A and the composition B.

It is equally possible, in a variant of the embodiment just described, shown in FIG. 3, to eliminate the conical region 51 so that the diameter reduction of the flow AB at the exit from the injection plate is controlled naturally by the surface energy of the compositions. In this case, the die 6 is no longer necessary and the flow is obtained directly from the plate 4.

Subsequently there is a step of irradiating the flow AB by means of a source 7 of UV radiation. The composition A is therefore cured to form the cladding polymer: this produces the photocrystalline plastic optical fiber F.

The distance between the source 7 of UV radiation and the die 6 is selected as a function of the diameters of the cavities and the fiber diameter that are required.

The cavities of the fiber F contain the uncured liquid composition B. For improved light propagation in the fiber F, the composition B is preferably selected so that its refractive index is lower than the refractive index of the cladding polymer (composition A).

The refractive index of the cladding polymer is from 1.3 to 1.6, for example. It is possible to produce the fiber F₁ from the fiber F by eliminating the liquid composition B, preferably by heat treatment using an oven 8, in which the composition B evaporates and is evacuated.

The optical fiber F₁ is wound onto a spool 10 with the aid of a capstan 9.

In a first variant of the method of the invention the liquid composition B is cured to form solid cavities by any means other than the given UV radiation source 6.

In a second variant of the method of the invention, after the liquid composition B is removed, the cavities are filled with another material having a suitable refractive index.

In another variant, the composition B is a gas and the injection pressure of the composition B is preferably higher than the injection pressure of the liquid composition A.

In a third variant of the method of the invention, a substantially central hole in the plate receives, instead of the composition A, a third liquid or gas composition C that does not respond to the UV radiation.

Thus it is possible to form a hollow core photocrystalline plastic optical fiber by eliminating the composition C.

It is preferably eliminated by heat treatment, for example a treatment exactly the same as that used to form the hollow cavities, especially if the composition C is a liquid and is substantially identical to the composition B.

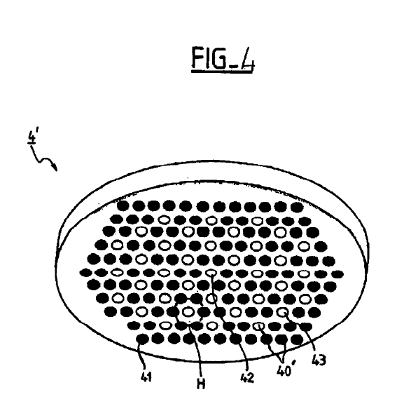

FIG. 4 is a diagrammatic perspective view of an injection plate 4′ with holes 40′ having a structure similar to that used in the preferred embodiment of the method of the invention.

The precursor composition of the cladding polymer, such as the composition A, is injected into a first series of holes 41 (shown black in FIG. 4), for example circular holes, disposed to allow the formation of the cladding matrix of a photocrystalline plastic optical fiber of the invention.

For example, a composition that is a core polymer precursor, such as the composition A, is injected into a substantially central circular hole 42 disposed to contribute to the formation of the solid core.

A composition that is unreactive to said ultraviolet radiation, such as the liquid composition B or a gas composition, is injected into a second series of holes 43, for example circular holes, having a substantially periodic distribution, a hexagonal distribution in this example. Each of the holes of the second series 43 has as its nearest neighbors six holes of the first series 41 which together form a hexagon H depicted in dashed line.

The size and the shape of the holes in the two series may be exactly the same or different.

For example, the diameter of the plate 4′ is equal to a few millimeters and its thickness is three to five times the diameter of the holes. The diameter of the holes is of the order of 100 microns, for example.

Each hole in the plate 4′ may be extended by a nozzle.

In a fourth variant of the method of the invention, a third series of holes with a periodic arrangement and smaller than those of the second series is produced in the plate 4′. These holes receive a liquid or gas composition D that is unreactive to the UV radiation and is preferably identical to the composition B, with the aim of forming interstitial cavities in addition to the larger cavities initially provided.

In a plastic optical fiber produced by the method of the invention, the distance between two adjacent cavities, the shape of the cavities, their diameter, their number, and their substantially periodic arrangement may be adjusted by modifying the second and/or first series of holes.

The invention also applies to the fabrication of a photocrystalline plastic optical fiber with optically coupled multiple cores.

1. A method of fabricating a photocrystalline plastic optical fiber having a core made of a core material and a cladding covering said core, said cladding being formed of at least a first substantially periodic arrangement of cavities of a cavity material disposed longitudinally in a cladding polymer matrix, said method for fabricating said cladding comprising the steps of:
a step of forming a flow by simultaneously injecting a liquid first composition that is a precursor of said cladding polymer and curable by ultraviolet radiation into a first series of holes in an injection plate, and a second composition that is unreactive to said ultraviolet radiation and is selected from a liquid composition and a gas composition into a second series of holes in said plate, said second series of holes having a substantially periodic distribution and each of said holes of said second series having as its closest neighbors holes of said first series; and
a step of irradiating said flow with ultraviolet radiation to form said photocrystalline plastic optical fiber.

2. The method claimed in claim 1 of fabricating a photocrystalline plastic optical fiber, wherein the time of contact between said compositions is less than one second.

3. The method claimed in claim 1 of fabricating a photocrystalline plastic optical fiber, wherein, for fabricating said core, said simultaneous injection operation comprises injecting into a substantially central hole of said plate separate from any hole of said series of holes a liquid third composition curable by ultraviolet radiation and preferably identical to said first composition.

4. The method claimed in claim 1 of fabricating a photocrystalline plastic optical fiber, wherein, for fabricating said core, said simultaneous injection operation comprises injecting into a substantially central hole of said plate separate from any hole of said series of holes a third composition that is unreactive to said ultraviolet radiation and is selected from a liquid composition and a gas composition.

5. The method claimed in claim 1 of fabricating a photocrystalline plastic optical fiber, wherein, for fabricating a second periodic arrangement of cavities, said simultaneous injection operation comprises injecting into a distinct third series of holes having a substantially periodic distribution a fourth composition that is unreactive to said ultraviolet radiation, is selected from a liquid composition and a gas composition, and is preferably identical to said second composition.

6. The method claimed in claim 1 of fabricating a photocrystalline plastic optical fiber comprising, after said irradiation step, at least one step of eliminating at least one of said unreactive compositions, preferably by heat treatment if said unreactive composition is a liquid.

7. The method claimed in claim 6 of fabricating a photocrystalline plastic optical fiber, wherein said elimination step leaves at least one region empty of liquid material and said method further comprises a step of filling said at least one region.

8. The method claimed in claim 1 of fabricating a photocrystalline plastic optical fiber, wherein the injection pressure of each unreactive gas composition is higher than the injection pressure of said first composition.

9. The method claimed in claim 1 of fabricating a photocrystalline plastic optical fiber, wherein the viscosity of each unreactive liquid composition is higher than the viscosity of the first composition and preferably less than five times the viscosity of said first composition.

10. The method claimed in claim 1 of fabricating a photocrystalline plastic optical fiber, wherein each curable composition contains a first reactive vinyl or acrylic monomer solvent and/or a first vinyl or acrylic polymer, the composition has an intrinsic attenuation less than 5 dB/m, and each unreactive composition (B) contains a compound selected from gases such as nitrogen, air, argon, unreactive solvents such as xylene, xylenol, butyl propanol, cyclohexanone, aliphatic alcohols, lactates, fluorinated solvents, butylene glycol, propylene glycol, silicone-containing oils, and biodegradable polymers such as cellulose polymers.
